(19) United States
(12) Patent Application Publication
(10) Pub. No.: US 2026/0188036 A1
(43) Pub. Date: Jul. 2, 2026

(54) LAYOUT AGNOSTIC IMAGE SEGMENTATION

(71) Applicant: Optum, Inc., Minnetonka, MN (US)

(72) Inventors: Dinesh Bajaj, Gurugram (IN); Mayank Chauhan, New Delhi (IN); Anant Saxena, Uttar Pradesh (IN)

(21) Appl. No.: 19/006,880

(22) Filed: Dec. 31, 2024

(51) Int. Cl. G06V 30/148; G06V 10/44; G06V 10/762; G06V 10/764; G06V 10/77; G06V 30/168; G06V 30/18; G06V 30/19; G06V 30/413; G06V 30/414

(52) U.S. Cl. CPC G06V 30/148; G06V 10/762; G06V 10/764; G06V 10/7715; G06V 30/168; G06V 30/19107; G06V 30/19173; G06V 30/413; G06V 30/414; G06V 10/44; G06V 30/1801

(57) ABSTRACT

Various embodiments of the present disclosure provide agnostic image segmentation techniques that improves the functionality of a computer in various aspects. The techniques comprise receiving image segmentation data that identifies a set of bounding boxes within an image; generating, using a clustering algorithm, and based on a y-axis distance between at least two bounding boxes within the set of bounding boxes, an initial bounding box cluster that comprises a first subset of bounding boxes; generating based on an x-axis distance between at least two bounding boxes within the initial bounding box cluster, a refined bounding box cluster from the initial bounding box cluster that comprises a second subset of bounding boxes; generating, a feature vector for the refined bounding box cluster based on a raw feature set; generating a segment classification for the refined bounding box cluster; and storing the raw feature set and the segment classification.

### BACKGROUND

In various domains, information is recorded and provided to a computer as images, such as joint photographic experts group (JPEG), portable document formats (PDF), portable network graphic (PNG) and/or the like, that depict information in a form interpretable to humans but less so to a computer. This has given rise to image processing techniques for converting image data, and/or other unstructured file types, to structured formats that may be digitized, stored, transferred, and/or processed by the internal mechanisms of the computer. Some image processing techniques comprises image segmentation techniques that may be applied to segment the content within an image into discrete content categories of related information.

Traditional image segmentation techniques may be limited to particular image structures and/or file types as they rely on prior information of a known image layout to segment the content within an image. These, layout specific image segmentation techniques, are limited to a subset of available formats and fail to generalize or adapt to new image layouts, which may be necessary is diverse image processing systems, such as those that receive images from several different sources. While some image segmentation techniques do allow for local variation in place, they traditionally rely on distance values along a single axis (e.g., y-axis) that fail to account for some components within an image, such as tables, charts, and other components that are arranged according to a different axis than other content within an image.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of an image segmentation technique in accordance with some embodiments of the present disclosure.

FIG. 5 depicts a data flow diagram of an example clustering technique in accordance with some embodiments of the present disclosure.

FIG. 6 depicts a dataflow diagram of an example feature vectorization technique in accordance with some embodiments of the present disclosure.

FIG. 7 depicts a flowchart diagram of an example image segmentation process in accordance with some embodiments of the present disclosure.

### DETAILED DESCRIPTION

Various embodiments of the present disclosure provide a layout agnostic image segmentation process that improves the functionality of a computer with respect to the accuracy, speed, and efficiency of various image processing tasks. To do so, the layout agnostic image segmentation process applies a staged clustering approach with different distance functions to sequentially cluster, along different axes, bounding boxes extracted from an image into refined bounding box clusters. By doing so, the layout agnostic image segmentation process may improve image recognition of unique image layouts in which content is arranged according to either axis and/or any combinations thereof. These improvements in image recognition allow for the extraction of comprehensive feature sets for refined segments of an image that may improve the training, and ultimately the performance (e.g., accuracy), of downstream image classification tasks by providing a more predictive representation of the image segment. In this manner, the layout agnostic image segmentation process may improve the functionality of computer with respect to both image recognition and downstream image processing tasks.

More particularly, some embodiments of the present disclosure provide a layout agnostic image segmentation process that improves the generalizability of traditional image segmentation techniques to images of different layout types. To do so, a staged clustering approach is applied with a modified distance function that first clusters bounding boxes of image along a y-axis and then refines the initial cluster through a second clustering operation along the x-axis. This, multi-axis clustering approach, improve the recognition of complex content elements, such as tables, graphs, and/or the like, that are arranged along multiple axes of an image. Moreover, the modified distance function may introduce a dynamic function for processing a distance between bounding boxes according to various metrics that enable the layout agnostic image segmentation process to generalize to any image layout by clustering the content of the image based on element level (e.g., bounding box level) comparisons as opposed to layout specific approaches. Taken together, the staged clustering approach and modified distance function may improve content clustering within images of any format. In this manner, the layout agnostic image segmentation process may be practically applied in various contexts to improve the image recognition of a computer with respect to different image layouts.

In addition, or alternatively, some embodiments of the present disclosure provide a feature engineering process that improves image segmentation classification with respect to traditional approaches. The feature engineering process, for example, may leverage combinations of cluster-level and element-level coordinate and content data extracted from a set of refined clusters of an image to generate a sequence of feature sets that comprehensive encode predictive features of the image within a machine readable format. For example, the feature engineering process may generate a cluster-level feature vector that encodes the cluster's coordinates and various predictive attributes (e.g., font style, font size, boldness, font color, and/or the like) of the content within coordinates that define both the cluster and the elements therein. The feature engineering process may then arrange individual cluster-level feature vectors in a feature vector sequence that more predictive of the various segment classifications within an image than previous approaches. In this manner, the feature engineering process may be practically applied in various machine learning contexts to improve the training (e.g., in terms of speed) and inference (e.g., in terms of accuracy) performance of machine learned image classification models.

Examples of technologically advantageous embodiments of the present disclosure comprise a modification of traditional image segmentation techniques to produce a layout agnostic image segmentation approach that may be practically applied to image segmentation in various contexts, among other aspects of the present disclosure. Examples of technology advantageous embodiments of the present disclosure provides for digitizing and converting unstructured text into structured information in various types of documents that solves downstream problems associated with various applications and systems. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

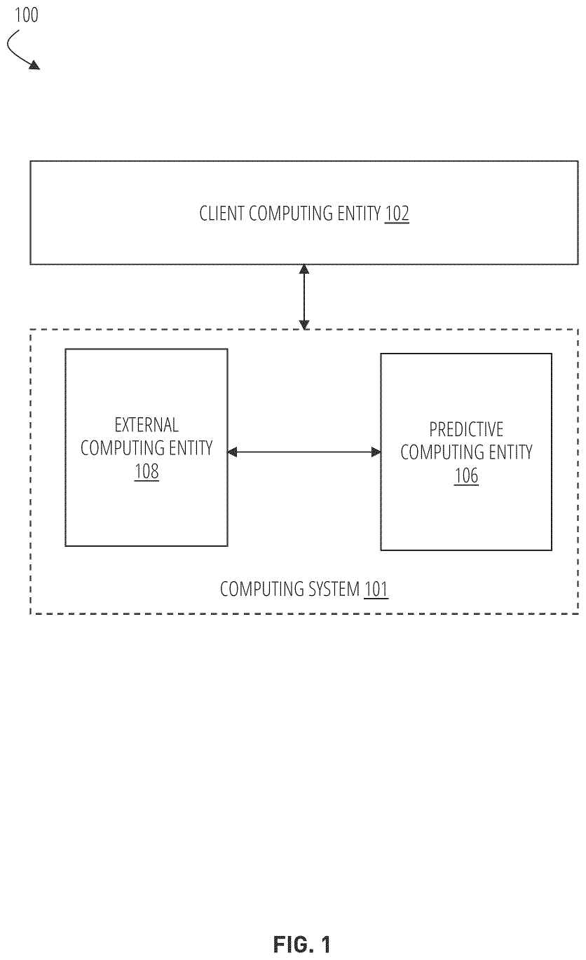

FIG. 1 depicts a block diagram of an example architecture 100 in accordance with some embodiments of the present disclosure. The architecture 100 comprises a computing system 101 configured to receive a request such a document layout request from client computing entities 102, process the request to generate an output, and provide the output to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate image segmentation data output, segment classification output, document layout output, and/or other machine learned outputs. The models may be adapted to an automated document layout generation framework comprising agnostic image segmentation techniques. Some techniques of the present disclosure may adapt traditional models to a cohesive framework, such as the automated document layout generation framework, for more efficiently handling portions of the document layout generation process.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., image segmentation techniques, clustering techniques, and/or other techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as image segmentation data, model data, training data, and/or the like to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

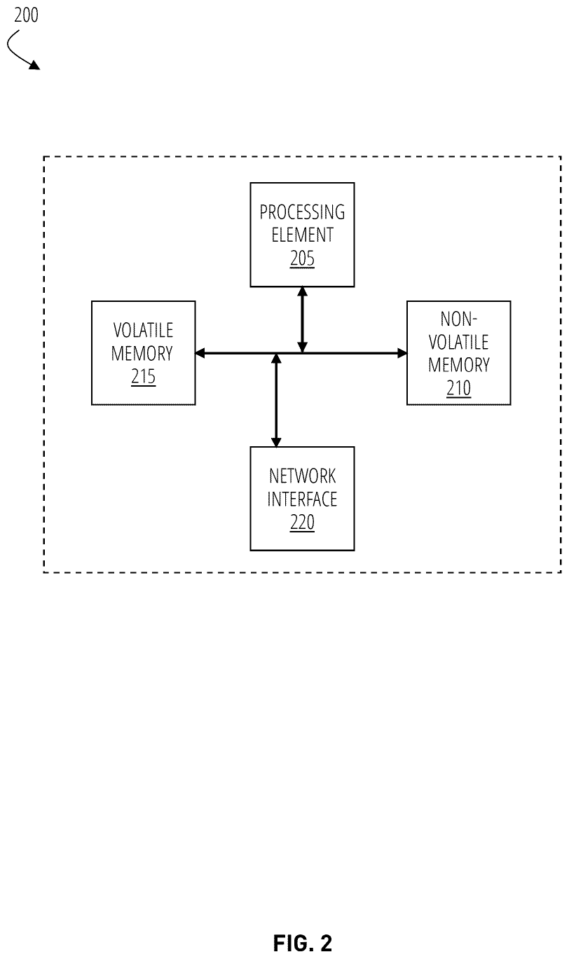

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile memory 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

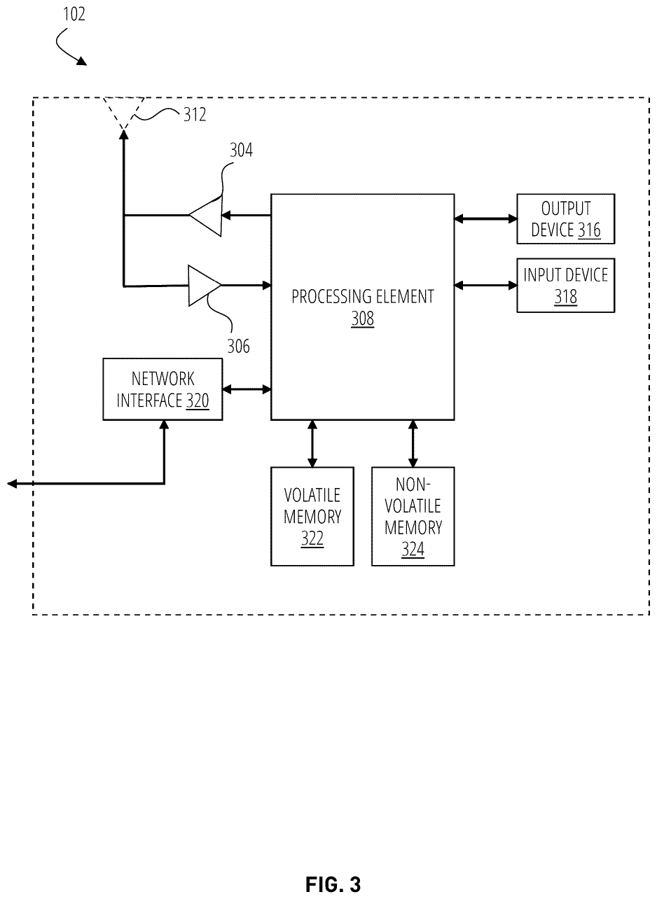

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to image segmentation, classification, and processing. In particular, systems and methods are disclosed herein that implement a layout agnostic image segmentation techniques that improve the generalizability, and accuracy, of image segmentation relative to traditional approaches. By doing so, the image segmentation techniques of the present disclosure enable improved image recognition and classification that, when executed on a computer, improves the image processing capabilities of a computer. This, in turn, may improve the functionality of a computer with respect to various computing tasks, including data ingestion, machine learning, network communication, and the like.

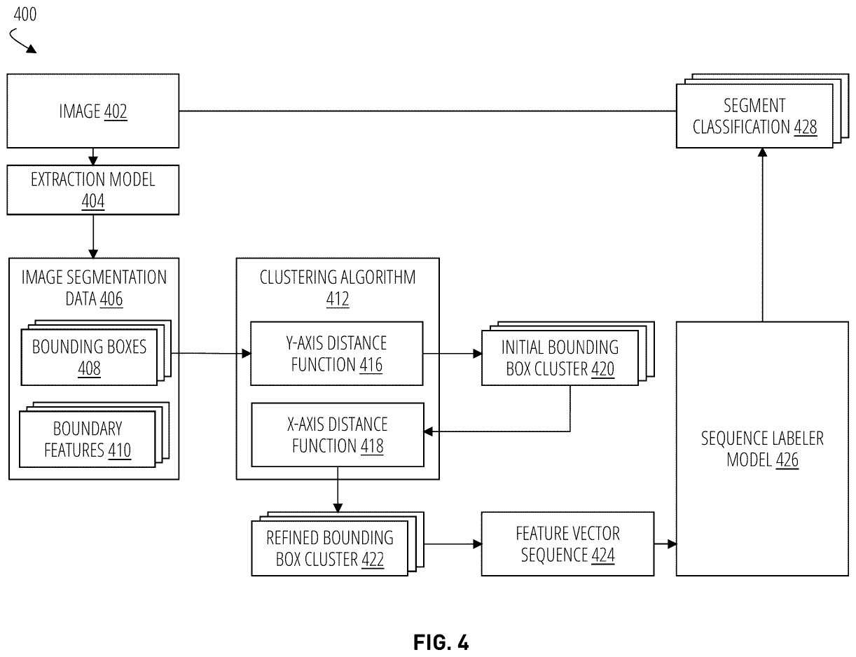

FIG. 4 depicts a dataflow diagram 400 of an example image segmentation technique in accordance with some embodiments of the present disclosure. As depicted, the image segmentation technique applies a staged clustering approach with different distance functions to sequentially cluster bounding boxes extracted from an image 402 into refined bounding box clusters 422. By doing so, the image segmentation technique may be implemented by a computing system, such as the computing system 101, to improve its image recognition of unique image layouts. To further improve the recognition of different layout types, the image segmentation techniques may leverage coordinate data and raw feature sets within a set of refined bounding box clusters to engineer features predictive of a segment type within an image. For example, using the techniques of the present disclosure, the computing system 101 may encode a unique set of features within a feature vector sequence 424 that may improve the performance (e.g., in terms of accuracy) of downstream machine learning image classifiers, such as the sequence labeler model 426.

In some embodiments, the image 402 comprises a digital representation of a document, which may be in various formats such as portable document format (PDF), joint photographic experts group (JPEG), portable network graphics (PNG), tag image file format (TIFF), or other formats. The digital representation may capture the content of the document, including, but not limited to, text, objects, graphics, and/or layout elements (e.g., boundary lines, borders, and/or the like). The image 402 may comprise a digital representation of various types of documents (e.g., contracts, forms, or healthcare documents, or the like), which may have different layout. For example, the image 402 may comprise a digital representation of a contract document having a first layout structure. As another example, the image 402 may comprise a digital representation of a medical chart having a second layout structure that is different from the first layout structure.

Additionally, or alternatively, a document may comprise different formats within the document. For example, different regions within a document may have different font sizes, spacing, and/or other formats. Additionally, or alternatively, a document comprise different segment types (e.g., heading, table, paragraphs, and/or the like) within the document. Additionally, or alternatively, the document may comprise unstructured text.

In some embodiments, the computing system 101 receives image segmentation data 406 that identifies a set of bounding boxes 408 within an image 402. In some examples, a bounding box of the set of bounding boxes 408 may comprise a raw feature set within a bounding box defined by a set of global image coordinates that comprise a subset of y-axis coordinates and/or a subset of x-axis coordinates. In addition, or alternatively, the image segmentation data 406 may comprise one or more boundary features 410. For example, the image segmentation data 406 may be received from an optical character recognition model 404, and/or the like.

In some embodiments, the image segmentation data 406 comprises one or more segmentation features that delineates the content within the image 402. In some embodiments, the segmentation features include bounding boxes such as the set of bounding boxes 408 that encapsulate individual elements within the image 402. The individual element may be a single word, a group of words, an object, a group of objects, and/or the like. In some embodiments, an individual element represents a single word from the textual content within the image 402. For example, the image segmentation data may delineate textual content (e.g., unstructured text, semi-structured text, structured text, and/or the like) within the image 402 at a word-level using the set of bounding boxes 408. For example, a bounding box of the set of bounding boxes 408 may comprise a raw feature set representative of a single word from the textual content within the image. In some other examples, the image segmentation data 406 may delineate the textual content at a character level, sentence level, or other levels of granularity.

Additionally, or alternatively, in some embodiments, the segmentation features comprise boundary features such as the one or more boundary features 410. The boundary features may comprise one or more structural layout elements within the image 402 such as, for example, lines and/or borders. For example, the one or more boundary features may include horizontal lines, vertical lines, and/or other lines from the document captured by the image 402.

The image segmentation data 406 may be generated by applying an optical character recognition model and/or other image recognition techniques to the image 402. This process may comprise detecting individual elements and delineating the individual elements using bounding boxes. This process may also comprise detecting the boundary features within the image 402. The optical character recognition model and/or image recognition techniques may comprise computer vision and machine algorithms, edge detection algorithms, line detection algorithms, and/or other algorithms. The optical character recognition model and/or other image recognition techniques may leverage one or more of these algorithms to process and/or analyze the pixel data of the image 402 to detect and delineate the individual elements within the image 402. In some example implementations, processing of the image 402 to generate the image segmentation data 406 may comprise using specialized software libraries or machine learning models trained on large datasets of images of different document layouts and formats.

In some embodiments, a bounding box 408 may comprise a geometric shape or other segmentation, such as a binary mask, that defines the location and size of an individual element within the image 402. The bounding box 408 may encapsulate the individual element. In an example where the bounding box is a geometric shape, the bounding box 408 may indicate a boundary of the individual element. In some embodiments, the geometric shape is a rectangular shape representing the smallest rectangular area encapsulating the individual element within a spatial space defined by and/or associated with the image 402. For instance, a bounding box 408 in the set of bounding boxes 408 may comprise a raw feature set representative of the individual element encapsulated by the bounding box 408. In an example where the bounding box is a mask, the bounding box may comprise an indication of the portion(s) of the image associated with an individual element, such as via a vector that indicates the pixels that are associated with the individual element or a binary vector that indicates, for each pixel in the image or a region of the image, whether each pixel is or is not associated with the individual element. In some embodiments, the individual element is a single word. For example, the bounding box 408 may comprise a word-level bounding box 408 that encloses an individual word from textual content within the image 402. In some other embodiments, the bounding box 408 may be a character-level bounding box, a sentence-level bounding box, or the like.

In some embodiments, the bounding box 408 is defined by global coordinates comprising a top left x-axis coordinate and a top left y-axis coordinate that represent the coordinates of the top left corner of the bounding box 408; a bottom left x-axis coordinate and a bottom left y-axis coordinate that represent the coordinates of the bottom left corner of the bounding box 408; a top right x-axis coordinate and a top right y-axis coordinate that represent the coordinates of the top right corner of the bounding box 408; and/or a bottom right x-axis coordinate and a bottom right y-axis coordinate that represent the coordinates of the bottom right corner of the bounding box 408

In addition, alternatively, the bounding box 408 may be defined by a combination of global and relative coordinates. In some examples, the coordinates defining the bounding box 408 may be stored as numerical values in a data structure, such as an array or object, within a computer's memory. For example, the coordinates of the bounding box 408 may be stored as numerical values in a coordinate system, where the origin (0,0) may represent the top-left corner of the image. The coordinates of the bounding box 408 may be calculated based on the detected edges or boundaries of the individual elements in the image 402. The bounding box 408 may be processed using one or more algorithms and/or techniques described herein to determine the spatial relationships between bounding boxes. Such spatial relationships may be used to detect the structure of the image 402, such as detecting columns, paragraphs, tables, and/or the like.

In some embodiments, a raw feature set comprises the content within a bounding box, which may include textual or image content. In the case of textual content, the raw feature set may be represented as a sequence of characters or words (e.g., along with their spatial coordinates) within the image 402. For example, the raw feature set may represent an image segment, such as a line of text, a paragraph, or a table cell. For image content, the raw feature set may include pixel data, color information, or other relevant visual features. In some embodiments, the raw feature set may encompass the content from each of the bounding boxes within a refined bounding box cluster.

In some example implementations, the raw feature set may be extracted from the image 402 using image processing libraries such as OpenCV for handling document images, and/or Optical Character Recognition (OCR) engines, such as Tesseract, for text recognition. In some example implementations, the extraction process may include preprocessing steps such as image binarization, noise reduction, and skew correction to improve the quality of extracted features.

In some embodiments, the y-axis coordinates of a bounding box 408 comprises one or more items of data representative of the vertical position of the bounding box 408 within the spatial space defined by or otherwise associated with the image 402. In some embodiments, the y-axis coordinates comprise a top left y-axis coordinate corresponding to the top left corner of the bounding box 408, a top-right y-axis coordinate corresponding to the top right corner of the bounding box 408, a bottom-left y-axis coordinate corresponding to the bottom left corner of the bounding box 408, and a bottom right y-axis coordinate corresponding to the bottom-left corner of the bounding box 408. The top left y-axis coordinate may comprise numerical data representative of the vertical position of the top left corner of the bounding box 408. The top right y-axis coordinate may comprise numerical data representative of the vertical position of the top-right corner of the bounding box 408. The bottom left y-axis coordinate may comprise numerical data representative of the vertical position of the bottom left corner of the bounding box 408. The bottom right y-axis coordinate may comprise numerical data representative of the vertical position of the bottom right corner of the bounding box 408.

In some embodiments, the x-axis coordinates of a bounding box 408 comprises one or more items of data representative of the horizontal position of the bounding box 408 within a spatial space defined by the image 402. In some embodiments, the x-axis coordinates comprise a top left x-axis coordinate corresponding to the top left corner of the bounding box 408, a top right x-axis coordinate corresponding to the top-right corner of the bounding box 408, a bottom left x-axis coordinate corresponding to the bottom left corner of the bounding box 408, and a bottom-right x-axis coordinate corresponding to the bottom right corner of the bounding box 408. The top left x-axis coordinate may comprise numerical data representative of the horizontal position of the top left corner of the bounding box 408. The top right y-axis coordinate may comprise numerical data representative of the horizontal position of the top-right corner of the bounding box 408. The bottom left x-axis coordinate may comprise numerical data representative of the horizontal position of the bottom left corner of the bounding box 408. The bottom right x-axis coordinate may comprise numerical data representative of the horizontal position of the bottom right corner of the bounding box 408.

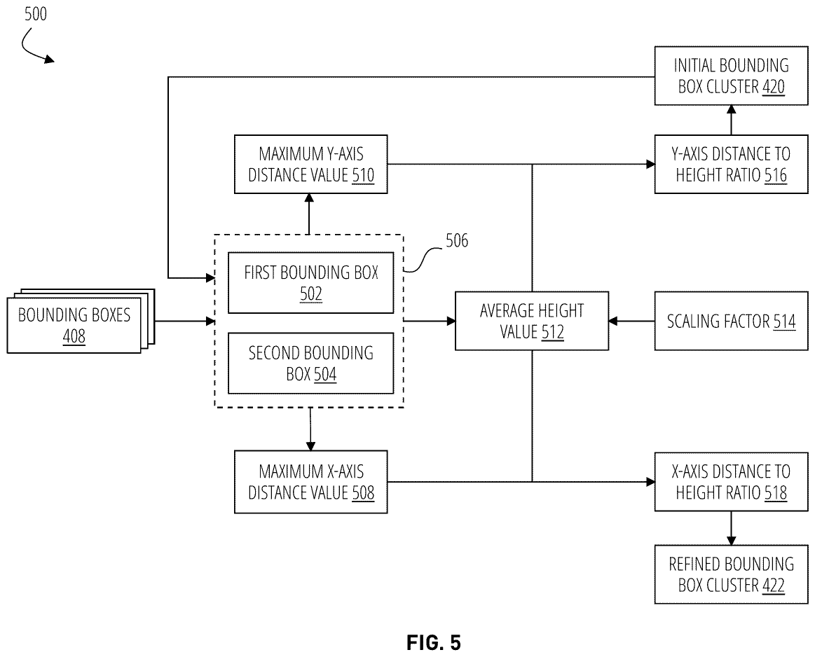

In some embodiments, the computing system 101 generates, using a clustering algorithm 412 with a y-axis distance function 416, an initial bounding box cluster 420 that comprises a first subset of bounding boxes from the set of bounding boxes 408. As described in further detail with reference to FIG. 5, the y-axis distance function 416 may define a modified distance measurement along the y-axis that may be used by the clustering algorithm 412 to assign bounding boxes of a box pair into the same or different bounding box clusters.

In some embodiments, the clustering algorithm 412 comprises an algorithm for grouping words or other elements of an image that are spatially close to each other. For example, the clustering algorithm 412 may be applied to the set of bounding boxes 408 identified by the image segmentation data 406 to detect distinct segments (e.g., paragraphs, columns, sections, tables, and/or the like) within the image 402 based on the spatial relationships between the bounding boxes. The clustering algorithm 412 incorporates and uses a dynamic distance function (also referred to herein as modified distance function) according to techniques of the present disclosure to generate clusters. The dynamic distance function comprise a y-axis distance function and/or an x-axis distance function.

The first subset of bounding boxes of the set of bounding boxes 408 may comprise one or more bounding boxes from the set of bounding boxes 408 that are vertically close together within the image 402 as determined using the clustering algorithm 412 and the y-axis distance function.

In some embodiments, the clustering algorithm is a density-based spatial clustering of applications with noise (DBSCAN) algorithm. A different clustering algorithm may be used in some other embodiments. The DBSCAN algorithm operates on a set of points (e.g., set of data points) in space corresponding to the spatial coordinates in the spatial space associated with the image 402. The DBSCAN algorithm groups together points that are closely packed together and marks points that lie alone in low-density regions as outliers or noise. The DBSCAN algorithm may iterate through the points, expanding clusters from points that satisfy the density requirements. The DBSCAN algorithm determines whether a point should be considered a part of a given cluster based on the proximity of the point to other points within a specified radius (epsilon) and a minimum number of points (minPts). For example, the DBSCAN algorithm may include an epsilon (ε) parameter, which specifies how close points should be to each other to be considered a part of a cluster. The DBSCAN algorithm may also include a minPts parameter, which specifies the minimum number of points to form a dense region. The DBSCAN algorithm's ability to handle clusters of arbitrary shape and its robustness to noise make it particularly suitable for varied layouts found in real-world documents. By way of example, the DBSCAN algorithm may be implemented using programming languages such as Python or C++, and/or utilizing specialized libraries such as scikit-learn, OpenCV, and/or the like. Although DBSCAN is discussed, additional or alternate clustering algorithms could be used, such as ordering points to determine the clustering structure (OPTICS), hierarchical DBSCAN (HDBSCAN), DBSCAN++, density-based clustering (DENCLUE), black hole clustering, protoclustering, hierarchical agglomerative clustering, mixture modeling (e.g., Gaussian mixture model (GMM), the Leiden algorithm, and/or the like.

In some embodiments, the computing system 101 generates, using the clustering algorithm 412 with an x-axis distance function 418, a refined bounding box cluster 422 from the initial bounding box cluster 420 that comprises a second subset of bounding boxes from the first subset of bounding boxes. As described in further detail with reference to FIG. 5, the x-axis distance function 418 may define a modified distance measurement along the x-axis that may be used by the clustering algorithm 412 to assign bounding boxes of a box pair into the same or different bounding box clusters.

In some embodiments, the computing system 101 generates a sorted cluster list based on the set of refined bounding box clusters. For example, the computing system 101 may sort and/or arrange the refined bounding box clusters 422 in accordance with a sorting criteria. The sorting criteria may sort the refined bounding box clusters 422 based on a top y-axis. In addition, or alternatively, the sorting criteria may sort the refined bounding box clusters 422 based on a left x-axis. By way of example, the computing system 101 may sort the refined bounding box clusters based on the top y-axis of up to each of the refined bounding box clusters (e.g., with a higher top y-axis ranked higher than a lower top y-axis). In some examples, the computing system 101 may sort refined bounding box clusters 422 with same y-axis based on their respective x-axes (e.g., with a leftmost left x-axis ranked higher than a rightmost left x-axis).

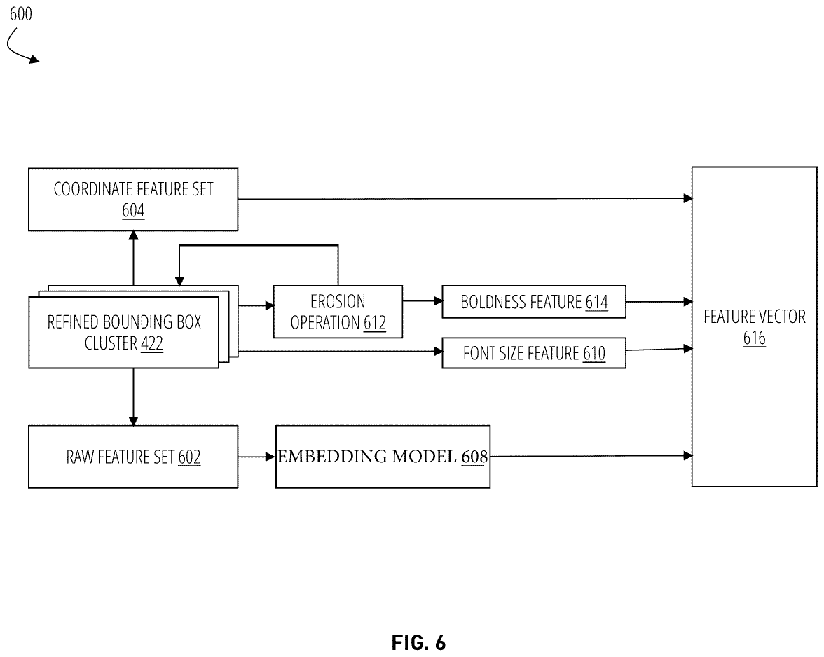

In some embodiments, the computing system 101 generates, using a sequence labeler model 426, a segment classification 428 for up to each refined bounding box cluster 422 based on a feature vector sequence 424 of the set of refined bounding box clusters 422. For example, as described in further detail with reference to FIG. 6, the computing system 101 may transform up to each refined bounding box cluster 422 of the set of refined bounding box clusters 422 to a feature vector to generate a set of corresponding feature vectors. The computing system 101 may concatenate the set of corresponding feature vectors to generate the feature vector sequence 424. In some embodiments, the sequence labeler comprises a decoder, encoder-decoder, and/or the like. In some examples, the computing system 101 may determine a sequence position of a feature vector within a feature vector sequence 424 based on a y coordinate and/or x coordinate of a corresponding refined bounding box cluster 422. For example, the feature vectors may be arranged within the feature vector sequence 424 based on the arrangement of their corresponding refined bounding box clusters 422 within the sorted cluster list. In some examples, the computing system 101 generates, using the sequence labeler model 426, the segment classification 428 for up to each of the set of refined bounding box clusters 422 based on the position of their respective feature vectors within the feature vector sequence 424.

A bounding box from the second subset of bounding boxes may comprise a group of elements from the first subset of bounding boxes that are horizontally close together within the image 402 as determined using the clustering algorithm 412 and the x-axis distance function.

In some embodiments, the feature vector comprises a combined vector representation of characteristics for a refined bounding box cluster. The feature vector may comprise a set of numerical values that capture various attributes of the refined bounding box cluster. These attributes may include the cluster box dimensions (e.g., size 4), text boldness (e.g., size 1), font size (e.g., size 1), and text embedding (e.g., size 512), resulting in a total of 518 features.

The feature vector may be implemented on a computer using data structures and algorithms designed to efficiently store and process high-dimensional numerical data. For example, the feature vector may be represented as an array or a tensor in memory, allowing for fast access and manipulation of its components. The functionality of feature vectors may comprise the capability to encapsulate both visual and semantic information about the image elements. By combining spatial information (e.g., cluster box dimensions), typographic attributes (e.g., text boldness and font size), and semantic content (e.g., text embedding), feature vectors may enable informed decisions about the classification of the image segments (e.g., corresponding to a document segment).

In some embodiments, the feature vector sequence 424 comprises a set of feature vectors. In some embodiments, the set of feature vectors may be up to each refined bounding box cluster within the image 402. The feature vector sequence 424 may be input to a sequence labeler model 426, which analyzes the set of feature vectors to classify the feature vectors. This sequential approach may allow the sequence labeler model 426 to consider the relationships and dependencies between different parts of the image, leading to more accurate and contextually aware classifications.

The functionality of the feature vector sequence 424 may comprises the capability to preserve the spatial and logical flow of the image layout (e.g., corresponding to the document layout). By maintaining the order of elements as they appear in the image 402, the feature vector sequence 424 may enable the sequence labeler model 426 to capture important contextual information, such as the progression from headings to paragraphs or the structure of tables.

In some embodiments, the sequence position comprises the sorted position of a refined bounding box cluster and its corresponding feature vector within the feature vector sequence 424. The sequence position may represent the relative order of the elements within the image based on their spatial arrangement in the image 402. The sequence position may be implemented as an integer index or a positional identifier associated with a feature vector in the feature vector sequence 424. This index may be zero-based or one-based, depending on the programming language and technique used. The sequence position may be determined during the sorting process, where refined bounding box clusters are arranged based on their top y-axis coordinates, and in case of ties, their left x-axis coordinates.

The functionality of the sequence position may comprise the capability to encode spatial relationships between document elements into a format that can be easily processed by the sequence labeler model 426. By preserving the original order of elements, the sequence position may enable the sequence labeler model 426 to learn and leverage patterns in image layouts, such as the typical progression from headings to paragraphs or the structure of tables in document.

In some embodiments, the sequence labeler model 426 comprises a machine learning model designed to classify elements of a sequence, such as the feature vectors of the feature vector sequence 424. The sequence labeler model 426 may be used to process the feature vector sequence 424 and assign a layout category to each feature vector. The classification process may involve analyzing the feature vectors in the feature vector sequence 424, including its spatial characteristics, typographic attributes, and semantic content, in the context of surrounding elements to determine the most appropriate layout category. For example, the sequence labeler model 426 may take as input the feature vector sequence 424 and output a corresponding sequence of labels, where each label represents the predicted layout category for the corresponding feature vector in the feature vector sequence 424 input to the sequence labeler model 426.

In some embodiments, the classification process may include granular classification schemes that detect sub-categories within major layout elements (e.g., differentiating between section headings, subsection headings, and paragraph headings). In some embodiments, the output of the sequence labeler model 426 comprises a sequence of probability distributions over the possible layout categories for a feature vector. The layout category with the highest probability may then be assigned as the classification for that segment.

The sequence labeler model 426 may be trained (e.g., previously trained) to assign layout categories to each feature vector in a feature vector sequence 424. The sequence labeler model may comprise a recurrent neural network (RNN) or a variant thereof, such as Long Short-Term Memory (LSTM) or Gated Recurrent Unit (GRU) networks, or a transformer-based machine-learned model, such as an encoder-decoder architecture or a decoder-only architecture. These architectures are particularly well-suited for processing sequential data as they can capture long-range dependencies and context within the feature vector sequence. In some embodiments, the sequence labeler model 426 may comprise bidirectional RNNs or transformer-based models, capable of considering both past and future context when making classifications. The model's parameters may be stored as multi-dimensional arrays (tensors) in memory, and the forward pass (inference) and backward pass (training) computations may be performed using specialized linear algebra libraries.

The functionality of the sequence labeler model 426 may comprises the ability to automatically detect and label the structural components of a document image, which enables downstream processes to interpret the image content in a meaningful way, such as distinguishing between titles, body text, and tabular data. Additionally, the functionality of the sequence labeler model 426 may comprises the ability to consider the context and relationships between feature vectors when making classification decisions. By processing the entire sequence, the sequence labeler model 426 may learn to recognize patterns and dependencies that span multiple elements, such as the relationship between headings and subsequent paragraphs or the structure of tables.

In some embodiments, the segment classification 428 comprises the output of a sequence labeler model 426 representative of a layout category. A layout category may represent and/or may be associated with particular segments within the image 402 corresponding to the document segments of the document represented by the image 402. Non-limiting examples of such layout categories include headings, paragraphs, tables, text, and other layout-specific designations that describe the structural and functional role of a segment within the image. The segment classification 428 may be generated through the application of the sequence labeler model 426 to the feature vector sequence 424. The segment classification 428 may be used to transform the unstructured or semi-structured representation of a document into a structured format that captures the document's logical layout. This structured representation facilitates further processing, such as information extraction, document understanding, and conversion to other formats. In some embodiments, the segment classification 428 may be hierarchical, allowing for the representation of nested structures within documents.

In some embodiments, the computing system 101 stores raw feature sets from the image 402 and the segment classifications 428 in association with the image 402.

FIG. 5 depicts a dataflow diagram 500 of an example clustering technique in accordance with some embodiments of the present disclosure. In some embodiments, in accordance with clustering technique, the computing system 101 generates a refined bounding box cluster 422 of the set of refined bounding box clusters 422 by clustering box pairs 506 based on a y-axis distance function and/or an x-axis distance function. For example, an initial bounding box cluster 420 may be based on the y-axis distance function and/or the refined bounding box cluster 422 may be based on the x-axis distance function. For instance, as described herein, the computing system 101 may apply the y-axis distance function to a box pair 506 to cluster a first bounding box 502 and/or second bounding box 504 of the box pair 506 in a same or different initial bounding box cluster 420. In addition, or alternatively, the computing system 101 may apply the x-axis distance function to a box pair 506 of an initial bounding box cluster 420 to further cluster the first bounding box 502 and/or the second bounding box 504 of the box pair 506 in a same or different refined bounding box cluster 422.

In some embodiments, a box pair 506 comprises a first bounding box 502 and/or a second bounding box 504 from a set of bounding boxes of an image and/or a subset of bounding boxes of an initial bounding box cluster 420 depending on a stage of the clustering technique. For example, at a first, y-clustering stage, the box pair 506 may comprise two bounding boxes from the set of bounding boxes of an image. In addition, or alternatively, in a second, x-clustering stage, the box pair 506 may comprise two bounding boxes from a subset of bounding boxes of the initial bounding box cluster 420. Up to each box pair 506 may comprise a bounding box (e.g., a first bounding box 502) and an adjacent bounding box (e.g., a second bounding box 504) within a particular set or subset of bounding boxes. In some embodiments, an adjacent box is determined by detecting a second bounding box 504 that is immediately next to the bounding box (e.g., first bounding box 502). In some embodiments, the adjacent bounding box is determined by comparing the coordinates (or portion thereof) of the bounding box (e.g., first bounding box 502) with a second bounding box 504 and determining that the second bounding box 504 is an adjacent bounding box with respect to the bounding box (e.g., first bounding box 502) if the result of the comparison of the coordinates fall within a specified range or otherwise satisfies a specified threshold. By way of example, the coordinates of the right side (e.g., top and bottom right corners) of the bounding box (e.g., first bounding box 502) may be compared with the coordinates of the left side (e.g., top and bottom left corners) of the second bounding box 504, and the second bounding box 504 may be determined to be an adjacent bounding box with respect to the bounding box (e.g., first bounding box 502) if the difference between the coordinates of the right side of the bounding box (e.g., first bounding box 502) and the coordinates of the left side of the second bounding box 504 is within a specified range or below a specified threshold.

In some embodiments, the box pair 506 comprises a set of two bounding boxes (e.g., adjacent bounding boxes) that may be grouped together or separated based on their spatial relationship. For example, a box pair may comprise two rectangular regions that enclose separate text or other elements within the image 402. In this regard, box pair 506 may be used in clustering operations to group related elements of the image 402 together. A bounding box in the box pair 506 may be represented by its coordinates in a two-dimensional space corresponding to the image 402. The decision to cluster two boxes together or keep them separate may be based on a y-distance function and/or x-distance function according to techniques described herein, which calculate the spatial proximity of the bounding boxes of the box pair 506.

In some embodiments, the computing system 101 determines, based on a subset of y-axis coordinates of a first bounding box 502 and/or second bounding box 504, a maximum y-axis distance value 510 between the box pair 506 that comprises the bounding box and an adjacent bounding box. The computing system 101 may determine a y-axis distance to height ratio 516 for the box pair 506 based on the maximum y-axis distance value 510, an average height value 512 of the box pair 506, and a scaling factor 514. The computing system 101 may determine, by the clustering algorithm, to include the bounding box and the adjacent bounding box in the initial bounding box cluster 420 based on the y-axis distance to height ratio 516. For example, the first bounding box 502 and the second bounding box 504 may be added to the same initial bounding box cluster 420 in response to a determination that the y-axis distance to height ratio 516 achieves a threshold (e.g., is less than a threshold distance, such as 0.1, 0.2, 1, or the like).

In some embodiments, the maximum y-axis distance value 510 comprises the largest vertical separation between two bounding boxes in a box pair. The maximum y-axis distance value 510 may represent a parameter of the modified y-axis distance function leveraged to determine the spatial relationships between elements in an image. The maximum y-axis distance value 510 may be calculated using the top and bottom y-axis coordinates of the two bounding boxes in the box pair. The maximum y-axis distance value may be represented as:

$$maximum y - axis distance value = max ( top y of box 2 , top y of box 1 ) - min ( bottom y of box 2 , bottom y of box 1 ) \qquad Equation 1$$

where: (i) max(top y of box 2, top y of box1) represents the maximum top y-axis coordinate between top y-axis coordinates of bounding box 2 and bounding box 1, and (ii) min (bottom y of box 2, bottom y of box1) represents the minimum bottom y-axis coordinate between bottom y-axis coordinates of bounding box 2 and bounding box 1. For example, the y-axis coordinates of the two bounding boxes may be compared to determine the maximum y-axis distance value. By capturing the largest vertical separation between two bounding boxes, the maximum y-axis distance value, provides a measure of how far apart the boxes are in the vertical dimension, regardless of their relative vertical positions (i.e., whether one is above the other or they overlap vertically).

In some embodiments, the average height value 512 comprises the mean/average of the heights of two bounding boxes. The average height value 512 may represent a parameter of the modified y-axis distance function described herein. In particular, the average height value 512 may represent a denominator in the y-axis distance function. By dividing the maximum y-axis distance by the average height, the y-axis distance function outputs a normalized value that is relative to the size of the elements being compared, which enables creation of a distance measure that works consistently across different font sizes and styles within a document. The average height value 512 may be calculated by summing the individual height values of the two bounding boxes in the box pair and dividing by two. The average height value 512 may be represented as:

$$average height = \frac{( height of box 1 + height of box 2 )}{2} \qquad Equation 2$$

The average height value 512 may provide valuable information about the scale of textual content or other content in different parts of the image 402. This information may be used to detect changes in font size, which may indicate headings, footnotes, or other structurally significant elements in the document layout of the image 402.

In some embodiments, the scaling factor 514 comprises a parameter of a dynamic distance function (e.g., modified y-distance function, modified x-distance function) for clustering bounding boxes. In particular, the scaling factor 514 may represent a percentage by which the height of a boundary box may be considered in calculating the distance function and impacts the formation of the bounding box clusters. By way of example, the scaling factor may be stored as a floating-point value in computer memory and accessed by the clustering algorithm during its execution. The clustering algorithm may dynamically adjust this value based on various factors, such as the type of image being processed or the characteristics of the text elements (or other elements) encountered. This dynamic adjustment may be implemented using conditional statements and mathematical operations within the algorithm's code. The scaling factor 514 may improve the accuracy of the clustering algorithm by allowing fine-tuning of the distance calculations. By adjusting the scaling factor, the algorithm can better account for variations in text size, spacing, and layout across different types of documents. This adaptability is particularly useful when processing documents with diverse formats or when dealing with documents that contain both text and tabular data.

In some embodiments, the y-axis distance to height ratio 516 comprises the output of the y-distance function representative of the vertical separation between two bounding boxes in a box pair 506. The modified y-axis distance function described herein may be implemented as a computational algorithm that takes as input the coordinates of the two bounding boxes and outputs the y-axis distance to height ratio 516. The y-axis distance function may calculate the y-axis distance to height ratio 516 based on the ratio of the maximum y-axis distance value between the bounding boxes to the average height value 512 of the bounding boxes scaled by a scaling factor. In particular, the y-axis distance function may calculate the maximum y-axis distance value 510 between the two bounding boxes of the box pair 506 and the average height value 512 of the two bounding boxes, and divide the maximum y-axis distance value 510 by the product of the average height and the scaling factor. The y-axis distance to height ratio may be represented as:

$$y - axis distance to height ratio = \frac{( maximum y - axis distance value )}{( average height of box pair ) * ( scaling factor )} \qquad Equation 3$$

The y-axis distance function may be used in the clustering algorithm to determine whether two bounding boxes should be considered part of the same cluster, which may correspond to content in the same line or paragraph of text. By incorporating the average height of the bounding boxes and a scaling factor, the y-axis distance function described herein provides a normalized measure of vertical distance (e.g., vertical separation) between the bounding boxes. This allows the clustering algorithm to make informed decisions about which bounding boxes should be grouped together, taking into account both their vertical separation and their relative sizes. This, in turn, allows for the clustering algorithm to adapt to the different font sizes and line spacings that may be present within the image 402. In this regard, the modified y-axis distance function enables a layout agnostic image segmentation according to techniques of the present disclosure, such that images with varying layouts and typographic styles may be processed using techniques described herein.

In some embodiments, the computing system 101 divides the initial bounding box cluster 420 into one or more clusters based on one or more boundary features within the image segmentation data 406. For example, the computing system 101 may divide an initial bounding box cluster 420 into one or more different initial bounding box clusters based on one or more boundary features (e.g., horizontal lines) that extend along the x-axis at least partially through the initial bounding box cluster 420.

In some embodiments, the computing system 101 determines, based on the subset of x-axis coordinates of, a maximum x-axis distance value 508 between a box pair 506 that comprises the bounding box and an adjacent bounding box. The computing system 101, for example, may determine an x-axis distance to height ratio 518 for the box pair 506 based on the maximum x-axis distance value 508, the average height value 512 of the box pair 506, and the scaling factor 514. The computing system 101 may determine, by the clustering algorithm, to include the bounding box and the adjacent bounding box in the refined bounding box cluster 422 based on the x-axis distance to height ratio 518. For example, the first bounding box 502 and the second bounding box 504 may be added to the same initial bounding box cluster 420 in response to a determination that the y-axis distance to height ratio 516 achieves a threshold (e.g., is less than a threshold distance, such as 0.1, 0.2, 1, or the like).

In some embodiments, the maximum x-axis distance value 508 comprises the largest horizontal separation between two bounding boxes in a box pair. The maximum x-axis distance value 508 may represent a parameter of the modified x-axis distance function leveraged to determine the spatial relationships between elements in the image 402. The maximum x-axis distance value 508 may be calculated using the left and right x-axis coordinates of the two bounding boxes in the box pair. The maximum x-axis distance value may be represented as:

$$maximum x - axis distance value = max ( left x of box 2 , left x of box 1 ) - min ( right x of box 2 , right x of box 1 ) \qquad Equation 4$$

where: (i) max(left x of box 2, left x of box1) represents the maximum left x-axis coordinate between left x-axis coordinates of bounding box 2 and bounding box 1, and (ii) min (right x of box 2, right x of box1) represents the minimum right x-axis coordinate between right x-axis coordinates of bounding box 2 and bounding box 1. For example, the x-axis coordinates of the two bounding boxes may be compared to determine the maximum x-axis distance value. By capturing the largest horizontal separation between two bounding boxes, the maximum x-axis distance value, provides a measure of how far apart the boxes are in the horizontal dimension, regardless of their relative horizontal positions.

In some embodiments, the x-axis distance to height ratio 518 comprises the output of a specially-configured x-distance function (e.g., modified x-distance function as described herein) representative of the horizontal separation between two bounding boxes in a box pair. The modified x-axis distance function may be implemented as a computational algorithm that takes as input the coordinates of two bounding boxes and outputs an x-axis distance to height ratio 518. The x-axis distance function may calculate the ratio of the maximum x-axis distance between the bounding boxes to the average height of the bounding boxes scaled by a scaling factor. In particular, the x-axis distance function may calculate the maximum x-axis distance value between the two bounding boxes of the box pair and the average height of the two bounding boxes, and divide the maximum x-axis distance by the product of the average height and the scaling factor. The x-axis distance function may be represented as:

$$x - axis to distance ratio = \frac{( maximum x - axis distance value )}{( average height of box pair ) * ( scaling factor )} \qquad Equation 5$$

The x-axis distance function may be used in the clustering algorithm (e.g., DBSCAN or the like) to determine whether two bounding boxes should be considered part of the same cluster, which may correspond to elements in the same line or paragraph of text. By incorporating the average height of the boxes and a scaling factor, the x-axis distance function provides a normalized measure of horizontal distance (e.g., horizontal separation) between bounding boxes. This allows the clustering algorithm to make informed decisions about which boxes should be grouped together, taking into account both their horizontal separation and their relative sizes. This, in turn, allows for the clustering algorithm to adapt to the different font sizes and line spacings that may be present within the image 402 and/or across images. In this regard, the modified x-axis distance function enables a layout agnostic image segmentation according to techniques of the present disclosure, such that images with varying layouts and typographic styles may be processed using techniques described herein.

In some embodiments, the computing system 101 further divides the refined bounding box cluster 422 into one or more clusters based on one or more boundary features within the image segmentation data. For example, the computing system 101 may divide a refined bounding box cluster 422 into one or more different refined bounding box clusters based on one or more boundary features (e.g., vertical lines) that extend along the y-axis at least partially through the refined bounding box cluster 422.

FIG. 6 depicts a dataflow diagram 600 of an example feature vectorization technique in accordance with some embodiments of the present disclosure. When implemented by a computing system 101, the feature vectorization technique may enable the generation of comprehensive feature sets that combine a set of features engineered from a refined bounding box cluster 422. The set of features, for example, may represent the boundaries (e.g., coordinate feature set 604) and/or one or more content features (e.g., boldness feature 614, font size feature 610, raw feature set 602) within refined bounding box cluster 422. By doing so, a feature vector for up to each of a set of refined bounding box clusters 422 may be generated that holistically represents a structure of an input image without requiring a priori information for image. This, in turn, may improve the performance (e.g., in terms of accuracy) of machine learning image classification models.

In some embodiments, the computing system 101 generates, and using an embedding model 608, a feature vector 616 for the refined bounding box cluster based on a raw feature set determined based at least in part on a portion of the image encapsulated by the second subset of bounding boxes. In some examples, a feature vector 616 may comprise at least one of a coordinate feature set 604 of a refined bounding box cluster 422, a text embedding, a boldness feature 614, and/or a font size feature 610. In some embodiments, the embedding model 608 comprises an encoder and/or a large language model.

In some embodiments, the coordinate feature set 604 comprises a set of spatial coordinates that define the boundaries of a refined bounding box cluster 422. The set of spatial coordinates may comprise the coordinates of the upper right corner, lower right corner, upper left corner, and lower left corner of the geometric shape that defines the refined bounding box cluster. The coordinate feature set 604 may be represented as pixel values in a two-dimensional coordinate system, where the origin (0,0) is located at the top-left corner of the image 402.

In some embodiments, the text embedding comprises vector representations of the combined text of a cluster. The text embeddings may comprise dense vector representations of the text that capture the semantic meaning and contextual relationships in a high-dimensional space. The text embeddings may provide a rich, semantic representation of the content within document segments, which allows for more sophisticated analysis of the document structure based on the meaning of the text rather than just its spatial arrangement.

The text embedding may be generated using an embedding model, which may comprise an encoder and/or a large language model. Generating the text embedding may comprise transforming words or phrases into numerical vectors, where the relative positions and distances between these vectors in the embedding space represent semantic relationships.

The embedding model may employ natural language processing (NLP) techniques and/or deep learning techniques and/or neural network architectures such as transformers, which can capture complex linguistic patterns and contextual information. The process of generating the text embedding may comprise applying the embedding model to the input text, and processing it through multiple layers of neural networks to produce the final embedding vector. These vectors may be of fixed dimensionality (e.g., 768 dimensions for Bidirectional Encoder Representations from Transformers (BERT) base model, although other dimensions and/or other NLP techniques may be used). In some examples, the vectors may be stored efficiently in vector databases for quick retrieval and comparison.

In some embodiments, the computing system 101 generates the font size feature based on an average y-axis coordinate associated with the second subset of bounding boxes.

In some embodiments, the font size feature 610 comprises one or more items of data representative of the average height of a group of bounding boxes. In some example, the font size feature 610 comprises a numerical value that represents the average height of the bounding boxes within a refined bounding box cluster. The font size feature 610 may provide a quantitative measure of the text size within a specific region of a document. For example, the font size feature 610 may provide valuable information about the visual hierarchy of text elements within a document, helping to distinguish between different types of content such as headings, body text, and footnotes. The font size feature may be particularly useful in scenarios where explicit font information is not available, such as in scanned documents or images of text.

The font size feature 610 may be calculated by analyzing the geometric properties of the bounding boxes that encapsulate individual text elements, such as characters or words. The process may comprise detecting individual bounding boxes within a cluster (which may be accomplished using computer vision techniques or OCR preprocessing techniques); extracting the height information from each bounding box, and computing the average of these heights to derive a single representative value for the cluster.

In some example implementations, image processing libraries and numerical computation tools may leveraged in the font size feature calculation process. For example, in a Python environment, libraries such as OpenCV might be used for bounding box detection, while NumPy may be employed for efficient numerical operations on the height data.

In some embodiments, the boldness feature 614 comprises one or more items of data representative of the thickness or visual weight of an element, such as text. In some embodiments, the boldness feature 614 comprises a numerical value that quantifies the thickness or visual weight of text within a refined bounding box cluster. In some embodiments, the boldness feature is determined by and/or corresponds to the number of erosion iterations required to completely erode the text within the cluster. The boldness feature 614 may derived through image processing techniques, using morphological operations. An erosion operation, which is a fundamental morphological transformation, may be applied iteratively to the text within the bounding box to determine the boldness feature. This process may comprise gradually reducing the thickness of the text strokes until they disappear completely.

The process may begin with binarizing the image within the bounding box, converting it to black and white. Then, an erosion kernel (a small matrix, often 3×3 pixels although other sizes may be used) may be defined and applied repeatedly to the binary image. The number of iterations required until all pixels within the bounding box become white (i.e., have a value of 255 in an 8-bit grayscale image) may be recorded as the boldness feature value. In some example implementations, the boldness feature calculation may comprise using image processing libraries such as OpenCV or similar tools. The boldness feature may be used to distinguish between different text styles and weights within a document. It can help in detecting headings, subheadings, and emphasized text, which often have greater boldness compared to regular body text. This information is valuable for document layout analysis, content structuring, and semantic understanding of the text hierarchy within a document.

In some embodiments, the computing system 101 applies a sequence of erosion operation 612 iterations to a bounding box of the second subset of bounding boxes (e.g., within the refined bounding box cluster 422) to iteratively erode the raw feature set within the bounding box until a stopping condition is detected. In some examples, the computing system 101 may determine the boldness feature 614 based on a number of the sequence of erosion operation 612 iterations.

In some embodiments, the erosion operation 612 comprises a sequence of image processing operations that progressively reduce the contrast between the content and background of an image. For example, each iteration of the erosion operation may further diminish the prominence of the foreground elements, such as text or shapes, within the image.

In some examples, the erosion operation 612 may be implemented using computer vision libraries such as OpenCV, scikit-image, or similar tools. The operation may comprise sliding a structuring element (also known as a kernel) over the image and replacing each pixel with the minimum value found within the neighborhood defined by the structuring element.

In a binary image, for example, the erosion operation shrinks the foreground (usually represented by black pixels) and enlarges the background (usually represented by white pixels). For grayscale images, the operation replaces each pixel with the minimum intensity value found in its neighborhood. The size and shape of the structuring element, which may be a small square or circle, may be adjusted to control the erosion effect.

The erosion operation iterations may be used to calculate boldness feature, The operation iterations may be applied until a stopping condition is met, such as when all pixels within a bounding box become white (i.e., reach the background intensity level, where background intensity level may refer to a brightness or darkness measure of the background of the image).

In some embodiments, the stopping condition comprises a condition for terminating a sequence of erosion operations. In some embodiments, the condition may be that all pixels within a bounding box are white (e.g., 255). For example, the stopping condition may comprise a predefined criterion that determines when to terminate a sequence of erosion operations. The stopping condition may be set as the point at which all pixels within a bounding box have reached a specific value, such as when they all become white (e.g., 255 in an 8-bit grayscale image).

In some examples, the stopping condition may be implemented as a conditional statement or a loop termination criterion within the image processing algorithm, which may comprise checking the pixel values of the processed image after each erosion iteration. This check may be performed using various methods, such as a pixel-wise comparison (e.g., iterating through each pixel in the bounding box and verifying if its value matches the target value (e.g., 255 for white), statistical analysis (e.g., calculating the mean or maximum pixel value within the bounding box and comparing it to a threshold), histogram analysis (e.g., examining the image histogram to determine if all pixels fall within a specific intensity range), and/or the like.

In some example implementation, the stopping condition often utilizes efficient array operations provided by libraries such as NumPy in Python or similar tools in other programming languages. These operations allow for quick evaluation of large pixel arrays, optimizing the performance of the erosion process.

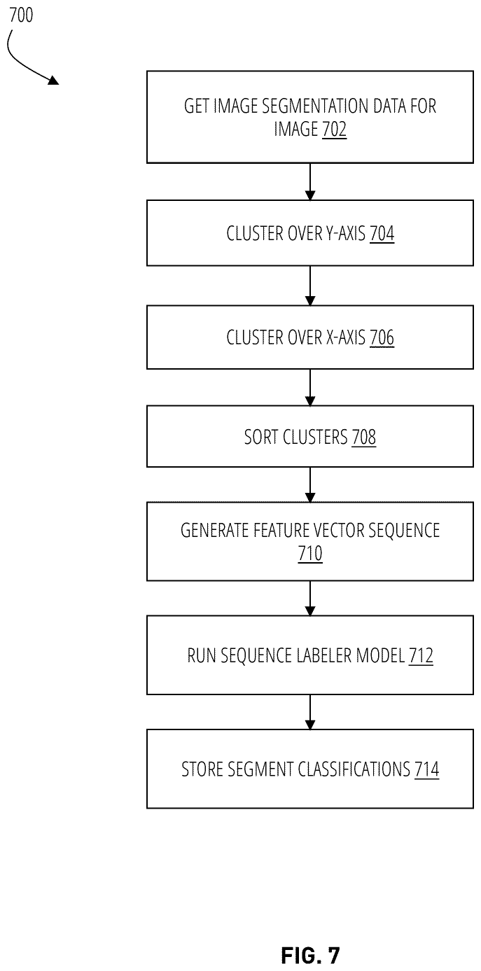

FIG. 7 is a flowchart diagram of an example image segmentation process 700 in accordance with some embodiments of the present disclosure. The flowchart diagram depicts an improved segmentation technique (e.g., in terms of accuracy) that applies a series of clustering operations to refine relevant clusters of content within an image. The process 700 may be implemented by one or more computing devices, entities, and/or systems described herein. For example, via the various steps/operations of the process 700, the computing system 101 may extract a set of refined bounding box clusters from an image that serve as a basis for enhanced feature vector sequence representations of the image. Using these enhanced feature vector sequences, the computing system 101 may segment the content within an image into a set of different segment classifications. By doing so, the process 700 improve computer functionality by improving the interpretation and processing accuracy of images relative to tradition image processing techniques.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, getting image segmentation data for image. For example, the computing system 101 may receive image segmentation data that identifies a set of bounding boxes within an image. In some examples, the image segmentation data may further comprise a boundary feature.

In some embodiments, the process 700 comprises, at operation 704, clustering the image segmentation data over the y-axis. For example, the computing system 101 may generates, using a clustering algorithm with a y-axis distance function, an initial bounding box cluster that comprises a first subset of bounding boxes from the set of bounding boxes. For example, the bounding box of the set of bounding boxes may be defined by a set of global image coordinates that comprise a subset of y-axis coordinates and/or a subset of x-axis coordinates. The computing system 101 may determine, based on the subset of y-axis coordinates, a maximum y-axis distance value between a box pair that comprises the bounding box and an adjacent bounding box. The computing system 101 may determine a y-axis distance to height ratio for the box pair based on the maximum y-axis distance value, an average height value of the box pair, and a scaling factor. In some examples, the computing system 101 may determine, by the clustering algorithm, to include the bounding box and the adjacent bounding box in the initial bounding box cluster based on the y-axis distance to height ratio. In some examples, the initial bounding box cluster may be further based on the boundary feature.

In some embodiments, the process 700 comprises, at operation 706, clustering the image segmentation data over the x-axis. For example, the computing system 101 may generates, using the clustering algorithm with an x-axis distance function, a refined bounding box cluster from the initial bounding box cluster that comprises a second subset of bounding boxes from the first subset of bounding boxes. For example, a bounding box of the first subset of bounding boxes may be defined by a set of global image coordinates that comprise a subset of y-axis coordinates and/or a subset of x-axis coordinates. The computing system 101 may determine, based on the subset of x-axis coordinates, a maximum x-axis distance value between a box pair that comprises the bounding box and an adjacent bounding box. The computing system 101 may determine an x-axis distance to height ratio for the box pair based on the maximum x-axis distance value, an average height value of the box pair, and a scaling factor. In some examples, the computing system 101 may determine, by the clustering algorithm, to include the bounding box and the adjacent bounding box in the refined bounding box cluster based on the x-axis distance to height ratio. In some examples, the initial bounding box cluster may be further based on the boundary feature.

In some embodiments, the process 700 comprises, at operation 708, sorting the clusters according to sorting criteria. For example, the computing system 101 may generate a sorted cluster list based on the set of refined bounding box clusters by sorting and/or arranging the refined bounding box clusters in accordance with a sorting criteria. The sorting criteria may sort the refined bounding box clusters based on a top y-axis. In addition, or alternatively, the sorting criteria may sort the refined bounding box clusters based on a left x-axis. By way of example, the computing system 101 may sort the refined bounding box clusters based on the top y-axis of up to each of the refined bounding box clusters (e.g., with a higher top y-axis ranked higher than a lower top y-axis). In some examples, the computing system 101 may sort refined bounding box clusters 422 with same y-axis based on their respective x-axes (e.g., with a leftmost left x-axis ranked higher than a rightmost left x-axis).

In some embodiments, the process 700 comprises, at operation 710, generating a feature vector sequence. For example, the computing system 101 may generate, and using an encoder, a feature vector for up to each refined bounding box cluster based on a raw feature set determined based at least in part on a portion of the image encapsulated by the second subset of bounding boxes. In some examples, a feature vector may comprise at least one of a coordinate feature set of a refined bounding box cluster, a text embedding, a boldness feature, and/or a font size feature.

In some embodiments, the computing system 101 applies a sequence of erosion operation iterations to a bounding box of the second subset of bounding boxes to iteratively erode the raw feature set within the bounding box until a stopping condition is detected. The computing system 101 may determine the boldness feature based on a number of the sequence of erosion operation iterations.

In some embodiments, the computing system 101 generates the font size feature based on an average y-axis coordinate associated with the second subset of bounding boxes.

In some embodiments, the process 700 comprises, at operation 712, running a sequence labeler model. For example, the computing system 101 may generate, using a sequence labeler model, a segment classification for the refined bounding box cluster based on the feature vector.

In some embodiments, the process 700 comprises, at operation 714, storing segment classifications. For example, the computing system 101 may store the raw feature set and the segment classification in association with the image.

Some techniques of the present disclosure enable the generation of action outputs that may be performed to initiate one or more real world actions to achieve real-world effects. The techniques of the present disclosure may be used, applied, and/or otherwise leveraged to facilitate resolution of problems associated with downstream processes of a workflow that relies on information from various documents. In some examples, the raw features set and/or segment classification of the present disclosure may trigger action outputs (e.g., through control instructions) to automate workflow actions, such as alerts, notifications, and/or the like. The action outputs may control various aspects of a client device, such as the display, transmission, and/or the like of data reflective of an alert, and/or the like. The alert may be automatically communicated to a user and/or may be used to initiate an automated workflow, robotic action, and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors, image segmentation data that identifies a set of bounding boxes within an image; generating, by the one or more processors using a clustering algorithm based on a y-axis distance between at least two bounding boxes within the set of bounding boxes function, an initial bounding box cluster that comprises a first subset of bounding boxes from the set of bounding boxes; generating, by the one or more processors, using the clustering algorithm, and based on an x-axis distance between at least two bounding boxes within the initial bounding box cluster, a refined bounding box cluster from the initial bounding box cluster that comprises a second subset of bounding boxes from the first subset of bounding boxes; generating, by the one or more processors and using an embedding model, a feature vector for the refined bounding box cluster based on a raw feature set determined based at least in part on a portion of the image encapsulated by the second subset of bounding boxes; generating, by the one or more processors and using a sequence labeler model, a segment classification for the refined bounding box cluster based on the feature vector; and storing, by the one or more processors, the raw feature set and the segment classification in association with the image.

Example 2. The computer-implemented method of example 1, wherein a bounding box of the set of bounding boxes is defined by a set of global image coordinates that comprise a subset of y-axis coordinates and a subset of x-axis coordinates and generating the initial bounding box cluster comprises: determining, based on the subset of y-axis coordinates, a maximum y-axis distance value between a box pair that comprises the bounding box and an adjacent bounding box; determining a y-axis distance to height ratio for the box pair based on the maximum y-axis distance value, an average height value of the box pair, and a scaling factor; and determining, by the clustering algorithm, to include the bounding box and the adjacent bounding box in the initial bounding box cluster based on the y-axis distance to height ratio.

Example 3. The computer-implemented method of any of the preceding examples, wherein a bounding box of the first subset of bounding boxes is defined by a set of global image coordinates that comprise a subset of y-axis coordinates and a subset of x-axis coordinates and generating the refined bounding box cluster comprises: determining, based on the subset of x-axis coordinates, a maximum x-axis distance value between a box pair that comprises the bounding box and an adjacent bounding box; determining an x-axis distance to height ratio for the box pair based on the maximum x-axis distance value, an average height value of the box pair, and a scaling factor; and determining, by the clustering algorithm, to include the bounding box and the adjacent bounding box in the refined bounding box cluster based on the x-axis distance to height ratio.

Example 4. The computer-implemented method of any of the preceding examples, wherein the image segmentation data further comprises an image boundary feature and the initial bounding box cluster or the refined bounding box cluster is based on the image boundary feature.

Example 5. The computer-implemented method of any of the preceding examples, wherein the feature vector comprises at least one of a coordinate feature set of the refined bounding box cluster, a text embedding generated by the embedding model based on text extracted from the portion of the image, a boldness feature, a font size feature, or an embedding generated by the embedding model based on at least one of the coordinate feature set, the text, the boldness feature, or the font size feature.

Example 6. The computer-implemented method of example 5, wherein the raw feature set comprises a text element and generating the feature vector for the refined bounding box cluster comprises generating, using the embedding model, the text embedding of the text element.

Example 7. The computer-implemented method of any of examples 5-6, wherein generating the feature vector for the refined bounding box cluster comprises generating the boldness feature by: applying a sequence of erosion operation iterations to a bounding box of the second subset of bounding boxes to iteratively erode content within the bounding box until a stopping condition is detected; and determining the boldness feature based on a number of the sequence of erosion operation iterations.

Example 8. The computer-implemented method of any of examples 5-7, wherein generating the feature vector for the refined bounding box cluster comprises generating the boldness feature based on an average y-axis coordinate associated with the second subset of bounding boxes.

Example 9. The computer-implemented method of any of the preceding examples, wherein the image segmentation data is received from an optical character recognition model.

Example 10. The computer-implemented method of any of the preceding examples, wherein generating the segment classification for the refined bounding box cluster based on the feature vector comprises determining a sequence position of the feature vector within a feature vector sequence based on a y-axis coordinate and an x-axis coordinate of the refined bounding box cluster; and generating, using the sequence labeler model, the segment classification based on the sequence position.

Example 11. A system comprising: one or more processors; and one or more memories storing processor-executable instructions that, when executed by the one or more processors, cause the one or more processors to perform operations comprising: receiving, by one or more processors, image segmentation data that identifies a set of bounding boxes within an image; generating, by the one or more processors using a clustering algorithm with a y-axis distance function, an initial bounding box cluster that comprises a first subset of bounding boxes from the set of bounding boxes; generating, by the one or more processors and using the clustering algorithm with an x-axis distance function, a refined bounding box cluster from the initial bounding box cluster that comprises a second subset of bounding boxes from the first subset of bounding boxes; generating, by the one or more processors and using an embedding model, a feature vector for the refined bounding box cluster based on a raw feature set determined based at least in part on a portion of the image encapsulated by the second subset of bounding boxes; generating, by the one or more processors and using a sequence labeler model, a segment classification for the refined bounding box cluster based on the feature vector; and storing, by the one or more processors, the raw feature set and the segment classification in association with the image.

Example 12. The system of example 11, wherein a bounding box of the set of bounding boxes is defined by a set of global image coordinates that comprise a subset of y-axis coordinates and a subset of x-axis coordinates and generating the initial bounding box cluster comprises: determining, based on the subset of y-axis coordinates, a maximum y-axis distance value between a box pair that comprises the bounding box and an adjacent bounding box; determining a y-axis distance to height ratio for the box pair based on the maximum y-axis distance value, an average height value of the box pair, and a scaling factor; and determining, by the clustering algorithm, to include the bounding box and the adjacent bounding box in the initial bounding box cluster based on the y-axis distance to height ratio.

Example 13. The system of any of examples 11-12, wherein a bounding box of the first subset of bounding boxes is defined by a set of global image coordinates that comprise a subset of y-axis coordinates and a subset of x-axis coordinates and generating the refined bounding box cluster comprises: determining, based on the subset of x-axis coordinates, a maximum x-axis distance value between a box pair that comprises the bounding box and an adjacent bounding box; determining an x-axis distance to height ratio for the box pair based on the maximum x-axis distance value, an average height value of the box pair, and a scaling factor; and determining, by the clustering algorithm, to include the bounding box and the adjacent bounding box in the refined bounding box cluster based on the x-axis distance to height ratio.

Example 14. The system of any of examples 11-13, wherein the image segmentation data further comprises an image boundary feature and the initial bounding box cluster or the refined bounding box cluster is based on the image boundary feature.

Example 15. The system of any of examples 11-14, wherein the feature vector comprises at least one of a coordinate feature set of the refined bounding box cluster, a text embedding generated by the embedding model based on text extracted from the portion of the image, a boldness feature, a font size feature, or an embedding generated by the embedding model based on at least one of the coordinate feature set, the text, the boldness feature, or the font size feature.

Example 16. The system of example 15, wherein the raw feature set comprises a text element and generating the feature vector for the refined bounding box cluster comprises generating, using the embedding model, the text embedding of the text element.

Example 17. The system of any of examples 15 or 16, wherein generating the feature vector for the refined bounding box cluster comprises generating the boldness feature by: applying a sequence of erosion operation iterations to a bounding box of the second subset of bounding boxes to iteratively erode content within the bounding box until a stopping condition is detected; and determining the boldness feature based on a number of the sequence of erosion operation iterations.

Example 18. The system of any of examples 15-17, wherein generating the feature vector for the refined bounding box cluster comprises generating the boldness feature based on an average y-axis coordinate associated with the second subset of bounding boxes.

Example 19. The system of any of examples 15-18, wherein the image segmentation data is received from an optical character recognition model.

Example 20. One or more non-transitory computer-readable media storing processor-executable instructions that, when executed by one or more processors, cause the one or more processors to perform operations comprising: receiving, by one or more processors, image segmentation data that identifies a set of bounding boxes within an image; generating, by the one or more processors using a clustering algorithm with a y-axis distance function, an initial bounding box cluster that comprises a first subset of bounding boxes from the set of bounding boxes; generating, by the one or more processors and using the clustering algorithm with an x-axis distance function, a refined bounding box cluster from the initial bounding box cluster that comprises a second subset of bounding boxes from the first subset of bounding boxes; generating, by the one or more processors and using an embedding model, a feature vector for the refined bounding box cluster based on a raw feature set determined based at least in part on a portion of the image encapsulated by the second subset of bounding boxes; generating, by the one or more processors and using a sequence labeler model, a segment classification for the refined bounding box cluster based on the feature vector; and storing, by the one or more processors, the raw feature set and the segment classification in association with the image.

What is claimed is:

1. A computer-implemented method comprising:
receiving, by one or more processors, image segmentation data that identifies a set of bounding boxes within an image;
generating, by the one or more processors, using a clustering algorithm, and based on a y-axis distance between at least two bounding boxes within the set of bounding boxes, an initial bounding box cluster that comprises a first subset of bounding boxes from the set of bounding boxes;
generating, by the one or more processors, using the clustering algorithm, and based on an x-axis distance between at least two bounding boxes within the initial bounding box cluster, a refined bounding box cluster from the initial bounding box cluster that comprises a second subset of bounding boxes from the first subset of bounding boxes;
generating, by the one or more processors and using an embedding model, a feature vector for the refined bounding box cluster based on a raw feature set determined based at least in part on a portion of the image encapsulated by the second subset of bounding boxes;
generating, by the one or more processors and using a sequence labeler model, a segment classification for the refined bounding box cluster based on the feature vector; and
storing, by the one or more processors, the raw feature set and the segment classification in association with the image.

2. The computer-implemented method of claim 1, wherein a bounding box of the set of bounding boxes is defined by a set of global image coordinates that comprise a subset of y-axis coordinates and a subset of x-axis coordinates and generating the initial bounding box cluster comprises:
determining, based on the subset of y-axis coordinates, a maximum y-axis distance value between a box pair that comprises the bounding box and an adjacent bounding box;
determining a y-axis distance to height ratio for the box pair based on the maximum y-axis distance value, an average height value of the box pair, and a scaling factor; and
determining, by the clustering algorithm, to include the bounding box and the adjacent bounding box in the initial bounding box cluster based on the y-axis distance to height ratio.

3. The computer-implemented method of claim 1, wherein a bounding box of the first subset of bounding boxes is defined by a set of global image coordinates that comprise a subset of y-axis coordinates and a subset of x-axis coordinates and generating the refined bounding box cluster comprises:
determining, based on the subset of x-axis coordinates, a maximum x-axis distance value between a box pair that comprises the bounding box and an adjacent bounding box;
determining an x-axis distance to height ratio for the box pair based on the maximum x-axis distance value, an average height value of the box pair, and a scaling factor; and
determining, by the clustering algorithm, to include the bounding box and the adjacent bounding box in the refined bounding box cluster based on the x-axis distance to height ratio.

4. The computer-implemented method of claim 1, wherein the image segmentation data further comprises an image boundary feature and the initial bounding box cluster or the refined bounding box cluster is based on the image boundary feature.

5. The computer-implemented method of claim 1, wherein the feature vector comprises at least one of a coordinate feature set of the refined bounding box cluster, a text embedding generated by the embedding model based on text extracted from the portion of the image, a boldness feature, a font size feature, or an embedding generated by the embedding model based on at least one of the coordinate feature set, the text, the boldness feature, or the font size feature.

6. The computer-implemented method of claim 1, wherein the segment classification identifies an image layout category associated with the refined bounding box cluster.

7. The computer-implemented method of claim 5, wherein generating the feature vector for the refined bounding box cluster comprises generating the boldness feature by:
applying a sequence of erosion operation iterations to a bounding box of the second subset of bounding boxes to iteratively erode content within the bounding box until a stopping condition is detected; and
determining the boldness feature based on a number of the sequence of erosion operation iterations.

8. The computer-implemented method of claim 5, wherein generating the feature vector for the refined bounding box cluster comprises generating the boldness feature based on an average y-axis coordinate associated with the second subset of bounding boxes.

9. The computer-implemented method of claim 1, wherein the image segmentation data is received from an optical character recognition model.

10. The computer-implemented method of claim 1, wherein generating the segment classification for the refined bounding box cluster based on the feature vector comprises:
determining a sequence position of the feature vector within a feature vector sequence based on a y-axis coordinate and an x-axis coordinate of the refined bounding box cluster; and
generating, using the sequence labeler model, the segment classification based on the sequence position.

11. A system comprising:
one or more processors; and
one or more memories storing processor-executable instructions that, when executed by the one or more processors, cause the one or more processors to perform operations comprising:
receiving, by one or more processors, image segmentation data that identifies a set of bounding boxes within an image;
generating, by the one or more processors using a clustering algorithm with a y-axis distance function, an initial bounding box cluster that comprises a first subset of bounding boxes from the set of bounding boxes;
generating, by the one or more processors and using the clustering algorithm with an x-axis distance function, a refined bounding box cluster from the initial bounding box cluster that comprises a second subset of bounding boxes from the first subset of bounding boxes;
generating, by the one or more processors and using an embedding model, a feature vector for the refined bounding box cluster based on a raw feature set determined based at least in part on a portion of the image encapsulated by the second subset of bounding boxes;
generating, by the one or more processors and using a sequence labeler model, a segment classification for the refined bounding box cluster based on the feature vector; and
storing, by the one or more processors, the raw feature set and the segment classification in association with the image.

12. The system of claim 11, wherein a bounding box of the set of bounding boxes is defined by a set of global image coordinates that comprise a subset of y-axis coordinates and a subset of x-axis coordinates and generating the initial bounding box cluster comprises:
determining, based on the subset of y-axis coordinates, a maximum y-axis distance value between a box pair that comprises the bounding box and an adjacent bounding box;
determining a y-axis distance to height ratio for the box pair based on the maximum y-axis distance value, an average height value of the box pair, and a scaling factor; and
determining, by the clustering algorithm, to include the bounding box and the adjacent bounding box in the initial bounding box cluster based on the y-axis distance to height ratio.

13. The system of claim 11, wherein a bounding box of the first subset of bounding boxes is defined by a set of global image coordinates that comprise a subset of y-axis coordinates and a subset of x-axis coordinates and generating the refined bounding box cluster comprises:
determining, based on the subset of x-axis coordinates, a maximum x-axis distance value between a box pair that comprises the bounding box and an adjacent bounding box;
determining an x-axis distance to height ratio for the box pair based on the maximum x-axis distance value, an average height value of the box pair, and a scaling factor; and
determining, by the clustering algorithm, to include the bounding box and the adjacent bounding box in the refined bounding box cluster based on the x-axis distance to height ratio.

14. The system of claim 11, wherein the image segmentation data further comprises an image boundary feature and the initial bounding box cluster or the refined bounding box cluster is based on the image boundary feature.

15. The system of claim 11, wherein the feature vector comprises at least one of a coordinate feature set of the refined bounding box cluster, a text embedding generated by the embedding model based on text extracted from the portion of the image, a boldness feature, a font size feature, or an embedding generated by the embedding model based on at least one of the coordinate feature set, the text, the boldness feature, or the font size feature.

16. The system of claim 15, wherein the raw feature set comprises a text element and generating the feature vector for the refined bounding box cluster comprises generating, using the embedding model, the text embedding of the text element.

17. The system of claim 15, wherein generating the feature vector for the refined bounding box cluster comprises generating the boldness feature by:
applying a sequence of erosion operation iterations to a bounding box of the second subset of bounding boxes to iteratively erode content within the bounding box until a stopping condition is detected; and
determining the boldness feature based on a number of the sequence of erosion operation iterations.

18. The system of claim 15, wherein generating the feature vector for the refined bounding box cluster comprises generating the boldness feature based on an average y-axis coordinate associated with the second subset of bounding boxes.

19. The system of claim 11, wherein the image segmentation data is received from an optical character recognition model.

20. One or more non-transitory computer-readable media storing processor-executable instructions that, when executed by one or more processors, cause the one or more processors to perform operations comprising:
receiving, by one or more processors, image segmentation data that identifies a set of bounding boxes within an image;
generating, by the one or more processors using a clustering algorithm with a y-axis distance function, an initial bounding box cluster that comprises a first subset of bounding boxes from the set of bounding boxes;
generating, by the one or more processors and using the clustering algorithm with an x-axis distance function, a refined bounding box cluster from the initial bounding box cluster that comprises a second subset of bounding boxes from the first subset of bounding boxes;
generating, by the one or more processors and using an embedding model, a feature vector for the refined bounding box cluster based on a raw feature set determined based at least in part on a portion of the image encapsulated by the second subset of bounding boxes;
generating, by the one or more processors and using a sequence labeler model, a segment classification for the refined bounding box cluster based on the feature vector; and
storing, by the one or more processors, the raw feature set and the segment classification in association with the image.
